(19) United States
(12) Patent Application Publication
(10) Pub. No.: US 2019/0014748 A1
(43) Pub. Date: Jan. 17, 2019

(54) System For Securing A Safety Device To A Leash

(71) Applicants: Bradley G. Jenkins, Monrovia, CA (US); Connor B. Jenkins, Monrovia, CA (US)

(72) Inventors: Bradley G. Jenkins, Monrovia, CA (US); Connor B. Jenkins, Monrovia, CA (US)

(21) Appl. No.: 15/651,686

(22) Filed: Jul. 17, 2017

(51) Int. Cl. A01K 27/00; G10K 9/04; F41H 13/00

(52) U.S. Cl. CPC A01K 27/008; A01K 27/009; F41H 13/0018; G10K 9/04

(57) ABSTRACT

A system for securing a safety device to a leash (SSSDL) that functions in combination with an animal leash that is used to restrain or control an animal which is typically a dog. The SSSDL has a securing member in the form of a bracket or an enclosure that is connected by attachment means to a surface of a leash. Removable attachment means including at least one strap, at least one cable, a hook and loop fastener, a double-sided tape or at least two gripping members, or permanent attachment means including at least one screw, at least one bolt and nut or an adhesive, can be utilized. The safety device preferably consists of a stun gun or an air horn, although other types of safety devices can be used with equal efficacy. For the bracket, the safety device is secured by means including at least one strip, at least one cable, a double-sided tape, or at least one clamp. For the enclosure, the safety device is inserted into and maintained within the enclosure. One of the main inventive features of the SSSDL is that the safety device can be actuated by a person while the person retains a grip on the leash and maintains control of an animal to which the leash is tethered.

### TECHNICAL FIELD

The invention generally pertains to personal safety products, and more particularly to a system that provides a safety device that is secured to a leash and that allows the safety device to be accessed and utilized while the leash is simultaneously used to restrain or control an animal.

### BACKGROUND ART

Throughout the world various animals are kept as pets or are used in industries such as entertainment or emergency response. The two most common animals designated as pets are dogs and cats. Cats are normally kept inside a dwelling, while dogs can be kept inside or outside. When a dog is kept inside it is necessary take the dog outside on a regular basis, usually at least once a day. When a dog is taken outside, responsible owners maintain restraint and control over the dog by use of a leash, which has one end secured on or around the dog's neck and the other end held by the owner. Leashes are not only used for dogs, as many animals, in many environments, must often be restrained and controlled.

In addition to the required outdoor visits a dog must have, many owners also take their dog on walks during running/jogging. At these times, a leash is also usually utilized. In fact, many cities, especially in urban areas of the United States, require by law that dogs must be on a leash when in a public environment.

A leash is not difficult to use and modern leashes have features such as automatic leash cable locking and retracting. A problem does exist when a person holding a leash needs to use his/her hands for another action. Typically, only one hand is available, since the other hand must hold onto the leash. This could potentially be dangerous in an emergency or safety-threatening situation. Attempts have been made to provide leash with extra functionality, but the most common example of this is the addition of a flashlight, which is often awkwardly attached to leash.

During certain emergency or safety-threatening situations the only benefit of having a flashlight is that a person can see what is happening; they usually cannot stop or impede what is happening with only a flashlight.

What is needed is an active means of stopping or otherwise engaging an emergency or threatening situation while maintaining an animal on a leash. The obvious solution is to modify a leash to include a safety device that could effectively be used in an emergency situation. Any number of events can occur when walking an animal, including, attack from another animal, attack from a person, or even just observing the occurrence an emergency or potential emergency. Including along with a leash, a safety device and making the device quickly and easily accessible and useable, while maintaining a grip on the leash, would be extremely beneficial.

A search of the prior art did not disclose any literature or patents that read directly on the claims of the instant invention. However, the following U.S. patents are considered related:

| PATENT NO. | INVENTOR | ISSUED |
|---|---|---|
| 5,429,075 | Passarella et al | Jul. 4, 1995 |
| 5,887,550 | Levine et al | Mar. 30, 1999 |
| 2010/0206246 | Waldrep | Aug. 19, 2010 |

The U.S. Pat. No. 5,429,075 discloses a combination leash apparatus for controlling the movements of an animal and retaining a flashlight. The apparatus includes a flexible elongate member, a collar engagement structure, a handle portion and a tubular retaining member attached to the member for removably retaining a flashlight. The apparatus additionally includes a supplemental compartment secured to the tubular retaining sleeve for retaining personal devices.

The U.S. Pat. No. 5,887,550 discloses a combined pet leash and flashlight comprising a mechanical dispensing and retracting cord for the purpose of tethering, restraining and controlling a pet during a walk.

The 2010/0206246 publication discloses a retractable animal leash combined with a pepper spray. The leash includes: a housing, a handle at a first side of the housing, a dispenser region in the handle, adapted to retain the spray canister and an attachment for the leash at a second side of the housing. A trigger activates the spray canister and has a safety cover. A reel with a brake allows the leash to extend and urges the leash to retract.

For background purposes and indicative of the art to which the invention relates, reference may be made to the following remaining patents found in the patent search.

| PATENT NO. | INVENTOR | ISSUED |
|---|---|---|
| 2,314,504 | Lifehultz | Mar. 23, 1943 |
| 4,887,552 | Hayden | Dec. 19, 1989 |
| 5,103,771 | Lee | Apr. 14, 1992 |
| 5,494,002 | Greene | Feb. 27, 1996 |
| 5,558,044 | Nasser, Jr. | Sep. 23, 1996 |
| 5,775,970 | Klees | Jul. 7, 1998 |
| 5,839,394 | Dickison | Nov. 24, 1998 |
| 6,371,055 | Lawrence | Apr. 16, 2002 |
| 2005/0172914 | Woodruff | Aug. 11, 2005 |
| 2006/0162675 | Ghalebi | Jul. 27, 2006 |
| 2007/0107669 | Eaton | May 17, 2007 |
| 2013/0000566 | Berton | Jan. 5, 2013 |

### DISCLOSURE OF THE INVENTION

The system for securing a safety device to a leash (SSSDL) functions in combination with a conventional animal leash that is used to restrain or control an animal such as a pet dog. There are a variety of leashes having various sizes and shapes, and the SSSDL is adaptable for use on almost any type of leash.

The main function of the SSSDL is to provide means of integrating a safety device onto the leash. The safety device can be any type, such as a stun gun or an air horn, which provides a person with defensive capability in the event of an emergency or threatening event or situation. When a person is walking an animal on a leash, the person and the animal can experience dangerous situations, such as an attack by another animal or another person. The danger can increase because of the fact that when using a leash, a person must maintain a grip on the leash at all times. Therefore, the ability of a person to defend themselves and/or their animal, is limited to a single hand. If a person must use both hands, he/she is forced to remove the hold on the leash, which allows the animal to either run away or become more susceptible to attack or injury.

The SSSDL provides a solution to this serious problem by providing a leash with a safety device, and the ability to actuate the safety device while simultaneously maintaining a firm grip on the leash (and control of their pet). This is accomplished by securing the safety device on the leash such that the device's actuator is positioned at an optimal location relative to a person's hand when holding the leash. Preferably, the device's actuator is directly accessible by the leash holder's thumb, which allows the four fingers to grip the leash handle and maintain the location of the leash and aiming of the safety device (when applicable), and at the same time use the thumb to actuate the safety device.

The SSSDL is comprised of a securing member that is placed and connected on a surface of a leash. Preferably, the leash's upper surface is utilized, as this location provides quick access to a safety devices actuator. The securing member can be connected by various attachment means including at least one strap, at least one cable, a hook and loop fastener, a double-sided tape, a tab and slot, or at least two gripping members. If the securing member is permanently connected to the leash, the means include at least one screw, at least one bolt and nut or an adhesive.

Once the securing member is connected to the leash, a safety device, such as the stun gun or air horn is either secured onto a bracket or within an enclosure. When the bracket is used, the safety device is secured by means including at least one strap, at least one cable, a double-sided tape, or at least one clamp.

In view of the above disclosure, the primary object of the invention is to provide a system for securing a safety device to a leash that facilitates a safety device such as a stun gun or an air horn to be secured onto a conventional animal leash in a manner that allows the safety device to be actuated while simultaneously maintaining a firm grip on the leash.

In addition to the primary object, it is also an object of the invention to provide a system for securing a safety device to a leash that:
is easy to use,
can be used for different types of animals or pets,
is durable and long lasting,
can include safety or non-safety accessories or devices,
can be made of various or multiple materials,
can significantly increase a person's personal safety when walking an animal
allows the accessories or devices to not interfere with the operation of the leash.
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic side view of a system for securing a safety device to a leash (SSSDL) showing a stun gun secured to a bracket by a cable and the bracket attached to an upper surface of a leash by a strap.

FIG. 2 is an orthographic top view of the SSSDL securing member bracket with a device interface channel and with attachment means extending from the bracket.

FIG. 3 is an orthographic side view of the SSSDL showing a stun gun secured by a strap, and the bracket attached by gripping members.

FIG. 4 is an orthographic side view of the SSSDL showing the bracket attached to a leash by a cable extending through a slot.

FIG. 5 is an orthographic side view of the SSSDL showing a stun gun secured to the bracket by double-sided tape, and the bracket attached to the leash by double-sided tape.

FIG. 6 is an orthographic side view of the SSSDL showing a stun gun secured to the bracket by a clamp, and the bracket attached to the leash by tabs and slots.

FIG. 7 is an orthographic side view of the SSSDL showing an enclosure that is attached to a leash by a strap, and an air horn inserted into and maintained within the enclosure.

FIG. 8 is an orthographic view of the SSSDL showing a stun gun within the enclosure, and on the bracket a positioning assembly with a rotating mechanism and locking means.

FIG. 9 is an orthographic top view of the SSSDL securing member bracket with a push-to-actuate mechanism located on the upper surface, adjacent to the rear of the channel, thereby allowing the push-to-actuate mechanism to interface with a safety device within the channel.

### BEST MODE FOR CARRYING OUT THE INVENTION

The best mode for carrying out the invention is presented in terms that disclose a preferred embodiment with multiple design configurations of a system for securing a safety device to a leash (SSSDL).

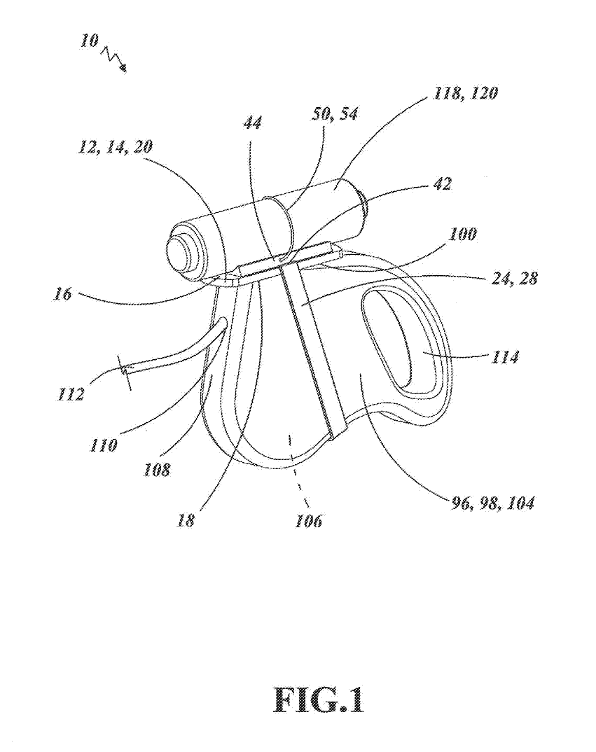

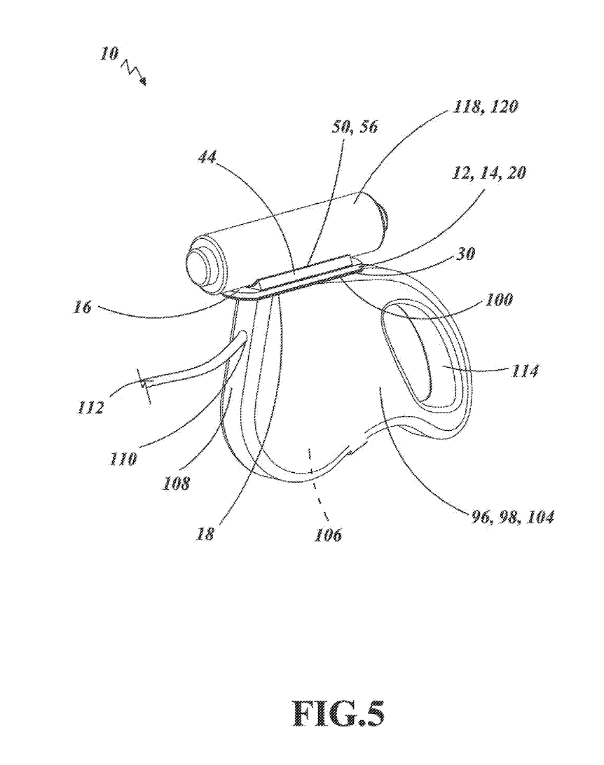

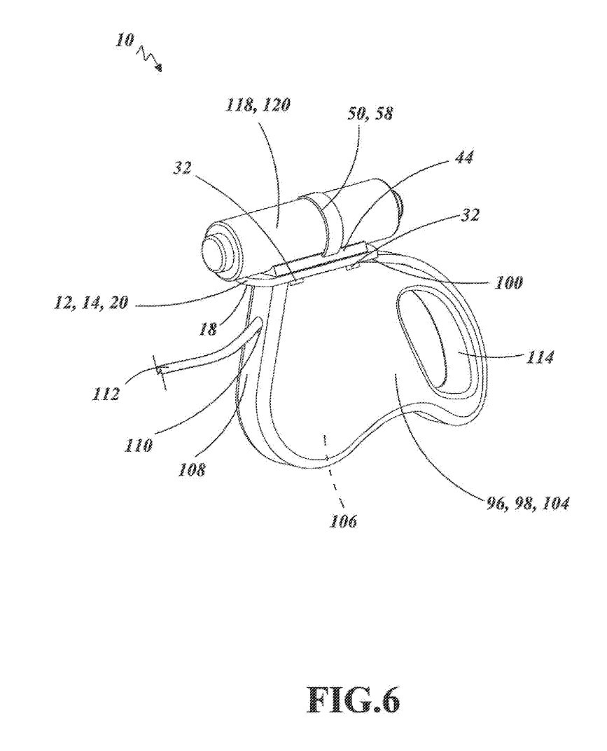

The SSSDL 10, as shown in FIGS. 1-9, functions in combination with a conventional animal leash that is used to restrain or control an animal which is most commonly a pet such as a dog. There are a variety of leashes having various sizes and shapes. For the purpose of this application, a typical leash will be disclosed and shown, but the SSSDL is not limited to any particular type of leash and the inventive concept can be effectively utilized with any type of leash. As shown in FIGS. 1, 3-7, the leash 96 includes a housing 98 with an upper surface 100, a lower surface 102, a first side surface 104, a second side surface 106, a front surface 108 having an opening 110 from where extends a cable 112, and a handle 114 located at the rear of the housing 98. The cable 112 is attached to an animal, normally via a collar that is around the animal's neck, and the leash 96 is held by a person by gripping the handle 114 with a hand(s).

The main function of the SSSDL 10 is to provide means of integrating a safety device 118 onto the leash. The safety device 118 can be any item or accessory that provides a person with defensive capability in the event of an emergency or threatening event or situation. When a person is walking an animal such as a pet dog on a leash, the person and the dog are typically in an outdoor environment and are exposed to potentially dangerous experiences, for example, an attack by another leashed or un-leashed dog, or another person. In rural areas the problem can also include the danger presented by the presence of wild animals. These and other problems are exacerbated by the fact that when using a leash, a person must maintain a grip on the leash at all times. Therefore, the ability of a person to defend themselves and/or their pet, is limited to a single hand/arm. If a person must use both hands he/she is forced to release the hold on the leash, which allows the pet to either run away or become more susceptible to attack or injury.

The SSSDL 10 provides a solution to this serious problem by providing a leash with a safety device, and the ability to actuate the safety device 118 while simultaneously maintaining a firm grip on the leash (and control of their pet). This is accomplished by securing the safety device 118 on the leash such that the device's actuator is positioned at an optimal location relative to a person's hand when holding the leash. Preferably, the device's actuator is directly accessible by the leash holder's thumb, which allows the four fingers to grip the leash handle and maintain the location of the leash and aiming of the safety device (when applicable), and at the same time use the thumb to actuate the safety device.

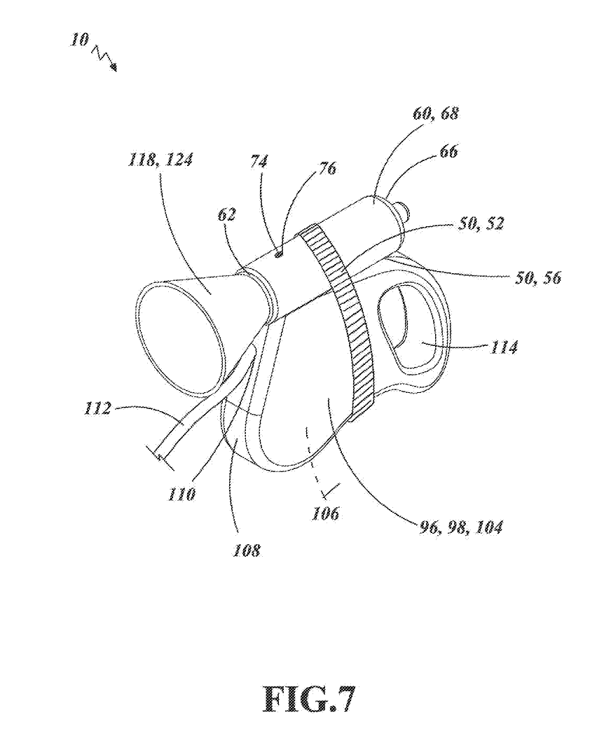

As previously disclosed, a variety of safety devices 118 can be utilized. For the purpose of this application, the safety device 118 will be limited to a stun gun 120, as shown in FIGS. 1, 2-6 and 8, or an air horn 124, as shown in FIG. 7, both of which can be used as a defensive measure in many different emergency or dangerous situations.

It should be noted that a stun gun 120 or an air horn 124 are just two examples of a safety device that can be utilized. The designs of the SSSDL 10 facilitate the use of many different types of safety (nor non-safety) devices, and it is anticipated that the functionality of the SSSDL can be modified and increased based on the requirements of other uses.

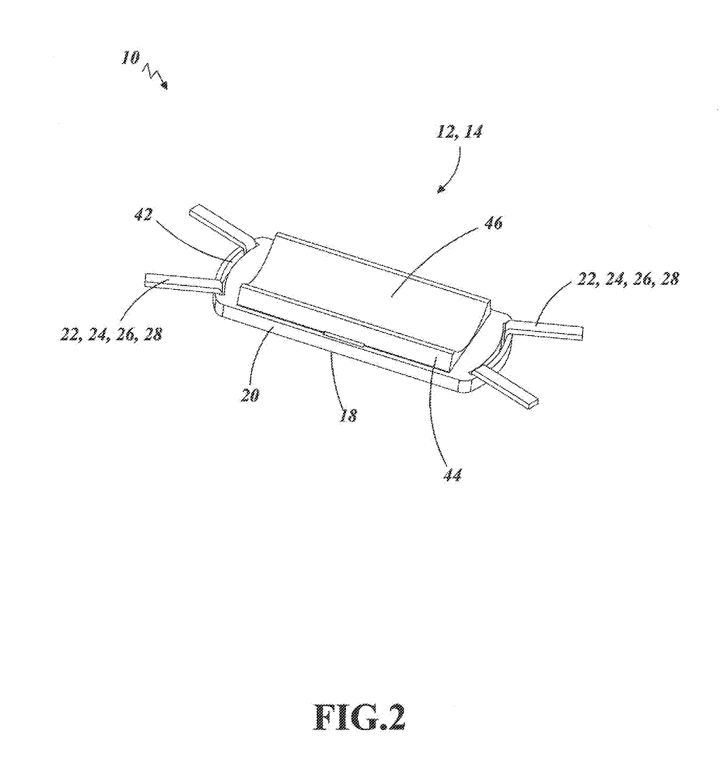

As shown in FIGS. 1-6, the SSSDL 10 has a securing member 12 comprising a bracket 14 that has an upper surface 16 with a device interface 44 having a channel 46, a lower surface 18 and a side edge 20. The design incorporating a channel 46 is only one example. The device interface 44 can have other structures as well, such as upward extending members with U-shaped slots (not shown). The functionality of the device interface 46 on the bracket 14 is to provide a type of cradle in the shape of the channel 46, as shown in FIG. 2, onto or into which a safety device 118 is placed.

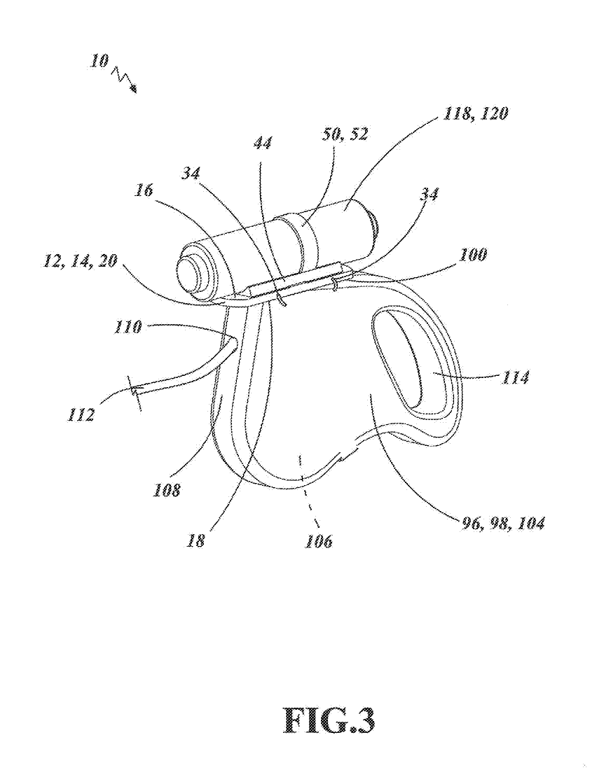

As shown in FIGS. 1, 3-6, the bracket's lower surface 18 is preferably placed on the leash's upper surface 100. While the leash's upper surface 100 is the preferred location, the bracket 14 can also be placed on other leash surfaces. The important consideration is to position the safety device so that the device's actuator is quickly and easily accessible while maintaining a grip on the leash. The bracket 14 is either removably attached or permanently attached by attachment means 22, preferably to the leash's upper surface 100, although other surface locations such as a side surface can also be utilized. The removable attachment can include at least one strap 24, at least one cable 26, a hook and loop fastener 28, a double-sided tape 30, a tab and slot 32, or at least two gripping members 34. While most of the removable attachment means are self-explanatory and well known in the art, the gripping members 34 are somewhat unique. As shown in FIG. 3, the gripping members are comprised of L-shaped or J-shaped claws that extend outward and downward from opposing side edges of the securing member. The gripping members are made of a resilient material that allows the members to flexibly engage the leash surface, thereby facilitating a gripping action that maintains the securing member 12 on the leash 96. When the strap(s), cable(s) or hook and loop fastener is used, the strap(s), cable(s) and fastener pass through slots 42, as shown in FIGS. 1, 2 and 4, located adjacent the lateral or longitudinal side edges, or they can extend over the safety device and under the bracket 14 or leash 96. The permanent attachment means can include at least one screw 36, at least one bolt 38 and nut, or an adhesive 40.

Once the bracket 14 is attached, a safety device 118 is placed and positioned within the channel 46 on the device interface 44. The safety device 118 is then secured within the channel 46 by securing means 50 that include at least one strap, at least one cable, a double-sided tape, or at least one clamp. With the safety device 118 secured and positioned on the bracket 14, the safety device can be actuated by a person while the person retains a grip on the leash 96 and maintains control of an animal to which the leash is tethered.

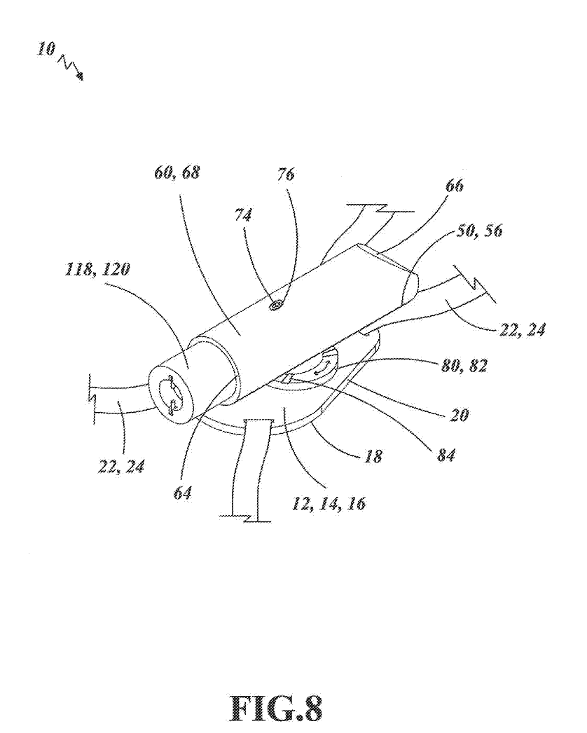

In order to increase the functionality of the bracket 14, a positioning assembly 80 can be incorporated. The positioning assembly 80, as shown in FIG. 8, allows the device interface 44 with a secured safety device 118 to be directionally positioned at selectable angles. The positioning assembly 80 comprises a rotating mechanism 22 that facilitates the directional angular positioning, and a locking means 84 that maintains the device interface 44 and safety device 118 at a selected position.

In a second design of the SSSDL 10, as shown in FIGS. 7-8, the securing member is comprised of an enclosure 60 that includes a front end 62 having an opening 64, a rear end 66 (which can also have an opening, not shown), an outer surface 68, an inner surface 70, and an actuator bore 72. The enclosure 60 is placed on the leash upper surface 100 and is attached by attachment means 22 to the upper surface. The attachment means 22 for the enclosure can be both the removable means or the permanent means that are utilized for the bracket 14. Once the enclosure 60 is attached, a safety device is inserted into the enclosure via the opening 64 on the front end 62. The opening 63 is dimensioned to allow the safety device 118 to be frictionally maintained within the enclosure. Additionally, to maintain a safety device 118 within the enclosure 60, a set screw 74, as shown in FIGS. 7 and 8, can be screwed into a threaded opening 76 on the enclosure 60. When the safety device is within the enclosure 60, the safety device actuator is accessible either through the open rear end 66 or the actuator bore 72 on the enclosure. The location can vary depending on where the actuator is on a particular stun gun 120 or air horn 124. The safety device 118 is actuated by a person while the person retains a grip on the leash and maintains control of an animal to which the leash is tethered. Optimally, the safety device's actuator is pressed by a person's thumb, which allows the four fingers to retain a grip on the leash handle 114.

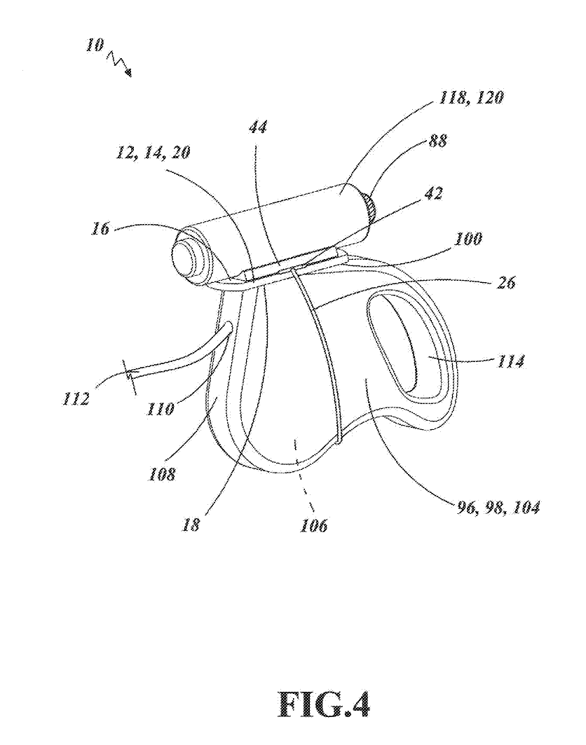

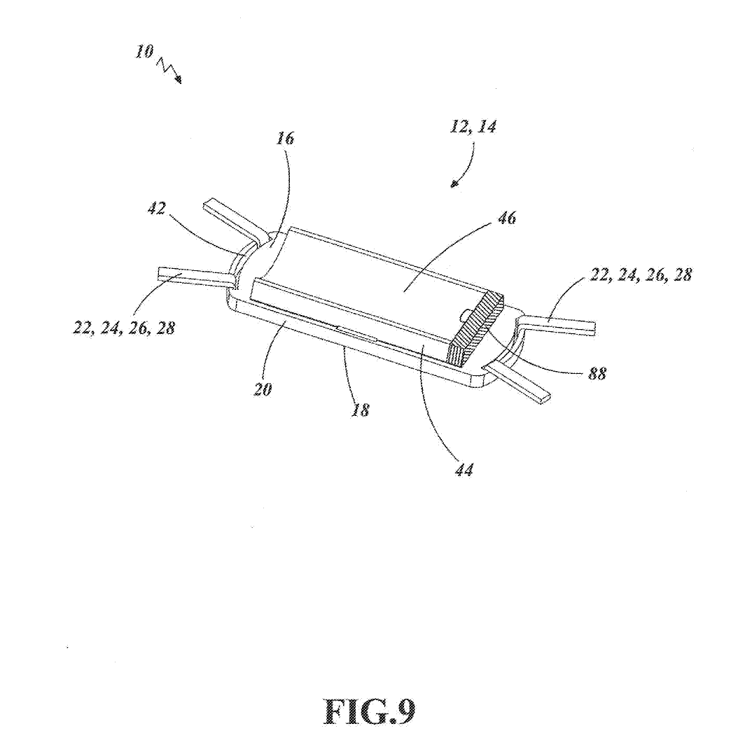

The enclosure 60 can also utilize the positioning assembly 80 as disclosed for use with the bracket 14. In addition, to add further utility to the SSSDL 10, when using a stun gun 120 as a safety device, a push-to-actuate mechanism 88 can be included on either the bracket design or the enclosure design. The push-to-actuate mechanism 88, as shown in FIGS. 4 and 9, functions in combination with a stun gun 120 to allow the stun gun to be actuated by pressing the stun gun's front end shock head into contact with a surface. The push-to-actuate mechanism 88 is located at the rear end 66 of the enclosure 60 and interfaces with the stun gun via a first contact and a second contact, with a spring between the two contacts. When a person applies forward pressure to force the stun gun into contact with a surface, the two contacts are connected which causes actuation. When the forward pressure is terminated, the spring forces the two contacts apart which causes the stun gun actuation to terminate.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A system for securing a safety device to a leash (SSSDL), wherein said SSSDL comprises a securing member that is connected by attachment means to a surface of an animal leash, wherein a safety device is secured to said securing member wherein once secured, the safety device is activated by a person while the person retains a grip on the leash and control of an animal to which the leash is tethered.

2. The system for securing a safety device to a leash as specified in claim 1 wherein the safety device is comprised of a stun gun.

3. The system for securing a safety device to a leash as specified in claim 1 wherein the safety device is comprised of an air horn.

4. The system for securing a safety device to a leash as specified in claim 1 wherein said securing member is comprised of a bracket having an upper surface with an device interface to which the safety device is secured.

5. The system for securing a safety device to a leash as specified in claim 1 wherein said securing member is comprised of an enclosure having an opening into which the safety device is inserted, wherein a bore on said enclosure having a bore allows access to an actuator on the safety device.

6. The system for securing a safety device to a leash as specified in claim 1 wherein said securing member is removably attached to a surface of the animal leash by attachment means that are selected from the group consisting of at least one strap, at least one cable, a hook and loop fastener, a double-sided tape or at least two gripping members.

7. The system for securing a safety device to a leash as specified in claim 1 wherein said securing member is permanently attached to a surface of the animal leash by attachment means that are selected from the group consisting of at least one screw, at least one bolt and nut, or an adhesive.

8. A system for securing a safety device to a leash (SSSDL) wherein said SSSDL functions in combination with an animal leash that has a housing with an upper surface, a lower surface, a first side surface, a second side surface, a front surface having an opening from where extends a cable, and a handle at a rear location, wherein said SSSDL includes a securing member comprising a bracket that has an upper surface with an device interface having a channel, a lower surface and a side edge, wherein said bracket lower surface is placed on the leash upper surface and said bracket is attached by attachment means to the upper surface of the leash, wherein once said bracket is attached, a safety device is placed and positioned within the channel on said device interface and secured thereto by securing means, wherein once secured and positioned, the safety device is actuated by a person while the person retains a grip on the leash and maintains control of an animal to which the leash is tethered.

9. The system for securing a safety device to a leash as specified in claim 8 wherein the safety device is comprised of a stun gun.

10. The system for securing a safety device to a leash as specified in claim 8 wherein the safety device is comprised of an air horn.

11. The system for securing a safety device to a leash as specified in claim 8 wherein said securing member is removably attached to a surface of the animal leash by attachment means that are selected from the group consisting of at least one strap, at least one cable, a hook and loop fastener, a double-sided tape or at least two gripping members.

12. The system for securing a safety device to a leash as specified in claim 11 wherein the gripping members are comprised of L-shaped or J-shaped claws that extend outward and downward from opposing side edges of said securing member, wherein the gripping members are made of a resilient material that allows the members to flexibly engage the leash surface, thereby facilitating a gripping action that maintains said securing member on the leash.

13. The system for securing a safety device to a leash as specified in claim 8 wherein said securing member is permanently attached to a surface of the animal leash by attachment means that are selected from the group consisting of at least one screw, at least one bolt and nut, or an adhesive.

14. The system for securing a safety device to a leash as specified in claim 8 wherein the securing means for securing the safety device to said bracket are selected from the group consisting of at least one strap, at least one cable, a double-sided tape, or at least one clamp.

15. The system for securing a safety device to a leash as specified in claim 8 wherein said bracket further comprising a positioning assembly that allows said device interface with a secured safety device to be directionally positioned at selectable angles, wherein said positioning assembly comprises a rotating mechanism that facilitates the directional angular positioning, and a locking means that maintains said device interface and safety device at a selected position.

16. A system for securing a safety device to a leash (SSSDL), wherein said SSSDL functions in combination with an animal leash that has a housing with an upper surface, a lower surface, a first side surface, a second side surface, a front surface having an opening from where extends a cable, and a handle at a rear location, wherein said SSSDL includes a securing member comprising an enclosure with a front end having an opening, a rear end, an outer surface, an inner surface, and an actuator bore, wherein said enclosure is placed on the leash upper surface and said enclosure is attached by attachment means to the upper surface of the leash, wherein once said enclosure is attached, a safety device is inserted into said enclosure via the opening on said front end, wherein the opening is dimensioned to allow the safety device to be frictionally maintained within said enclosure, wherein when the safety device is within said enclosure, the safety device actuator is accessible through the actuator bore on said enclosure, wherein the safety device is actuated by a person while the person retains a grip on the leash and maintains control of an animal to which the leash is tethered.

17. The system for securing a safety device to a leash as specified in claim 16 wherein the means for attaching said accessory tube to a surface of said enclosure are selected from the group consisting of an adhesive, at least one screw, at least one nut and bolt, or integrally during manufacturing.

18. The system for securing a safety device to a leash as specified in claim 16 wherein said personal safety accessory or device is comprised of a stun gun, wherein an opening on said enclosure allows access to an actuation switch on the stun gun.

19. The system for securing a safety device to a leash as specified in claim 16 wherein said securing member is removably attached to a surface of the animal leash by attachment means that are selected from the group consisting of at least one strap, at least one cable, a hook and loop fastener, a double-sided tape or at least two gripping members.

20. The system for securing a safety device to a leash as specified in claim 19 wherein the gripping members are comprised of L-shaped or J-shaped claws that extend outward and downward from opposing side edges of said securing member, wherein the gripping members are made of a resilient material that allows the members to flexibly engage the leash surface, thereby facilitating a gripping action that maintains said securing member on the leash.

21. The system for securing a safety device to a leash as specified in claim 16 wherein said securing member is permanently attached to a surface of the animal leash by attachment means that are selected from the group consisting of at least one screw, at least one bolt and nut, or an adhesive.

22. The system for securing a safety device to a leash as specified in claim 15 wherein said enclosure further comprising a positioning assembly that allows said enclosure with an inserted safety device to be directionally positioned at selectable angles, wherein said positioning assembly comprises a rotating mechanism that facilitates the directional angular positioning, and a locking means that maintains said enclosure and safety device at a selected position.

23. The system for securing a safety device to a leash as specified in claim 18 further comprising a push-to-actuate mechanism that functions in combination with the stun gun to allow the stun gun to be actuated by pressing the stun gun's front end shock head into contact with a surface, wherein said push-to-actuate mechanism is located at the rear end of said enclosure and interfaces with the stun gun via a first contact and a second contact, with a spring between the two contacts wherein when a person applies forward pressure to force the stun gun into contact with a surface, the two contacts are connected which creates a required actuation action, wherein when the forward pressure is terminated, the spring forces the two contacts apart which causes the stun gun actuation to terminate.
